(19) United States
(12) Patent Application Publication
(10) Pub. No.: US 2016/0314508 A1
(43) Pub. Date: Oct. 27, 2016

(54) CUSTOMER CENTRIC PARKING SYSTEM

(71) Applicant: PARK 'N FLY SERVICE LLC, ATLANTA, GA (US)

(72) Inventors: MICHAEL DAVID DEADERICK, SMYRNA, GA (US); ANTHONY L PAALZ, JR., ATLANTA, GA (US); WILLIAM DUTCH MILLARD, KENNESAW, GA (US); MICHAEL ANTHONY ROBINSON, ALPHARETTA, GA (US)

(21) Appl. No.: 15/136,370

(22) Filed: Apr. 22, 2016

Related U.S. Application Data
(60) Provisional application No. 62/151,866, filed on Apr. 23, 2015.

(51) Int. Cl. G06Q 30/02; G06Q 10/02

(52) U.S. Cl. CPC G06Q 30/0284; G06Q 10/02; G06Q 30/0226

(57) ABSTRACT

Disclosed is a method, system, and computer-readable medium for enabling a cross-platform, multi-component customer centric system for parking is provided. The method includes identifying a plurality of payment options which allow a customer to balance convenience, expense and self-service to enable a customer centric parking experience. The method also a plurality of means by which a customer can engage or book parking combining corporate information, loyalty information, customer affiliation information and proprietary revenue management techniques which enable a highly customer centric set of choices on how, when and where to book parking.

### CROSS-REFERENCE TO RELATED APPLICATIONS

This application claims priority to and the benefit of U.S. NonProvisional Application No. 62151866, filed Apr. 23, 2015, entitled “CUSTOMER CENTRIC PARKING SYSTEM”. Said application 62151866 is incorporated herein in its entirety.

### FIELD

The present disclosure relates to customer centric entry and exit processes and, more particularly, to a system, method, and computer readable medium for enabling a cross-platform, multi-component customer centric system for vehicle parking in a combined innovative manner.

### BACKGROUND

It is known in the prior art to provide reservations and drive up options for vehicle parking; indeed, these prior art methods constitute the primary means by which customers interact with parking facilities and operators. Such methods may provide some information about a customer but this information is rarely retained for future use. Another common means of customer information retention is the use of a customer loyalty program which allows retention of customer information and activity to facilitate information exchanges between the customer and the parking facility. This is commonly done using physical cards and/or online tools to self-identify the customer and retrieve/use the information in the desired medium.

Examples of prior art include the following: Method of building up a data bank containing customer data and/or for the organization of a rebate or coupon system (U.S. Pat. No. 6,039,244); Chipless RFID tag and method for communicating with the RFID tag (U.S. Pat. No. 8,068,010 B2); Electronic Valet Parking Kiosk System and Method (US 20120194354 A1); Method, apparatus and system for management of information content for enhanced accessibility over wireless communication networks (U.S. Pat. No. 7,599,983).

Systems and methods such as those described above present integration challenges which require users to access disparate systems and methods by which to request and pay for parking and related services. This leads to fragmented information and multiple accounts which do not leverage the same data or methods by which they are used and updated. Thus a need exists for an innovative way to request and pay for parking and related services which provides improved customer options.

### SUMMARY

The present disclosure addresses the above and other needs and provides advantages by providing highly convenient and complex processing to enable customer centric payment of parking and services together or separately, as well as with multiple forms of payment. The method includes the use of a Parking Reservations Engine in so far as it is used to support or facilitate customer centric processing. The method also includes the use of a Customer Loyalty system in the extensions and innovations necessary to support this customer centric parking disclosure. The innovation centralizes around the methods and extensions provided by each of the components as well as the novelty of the Gate Control System in enabling these methods and extensions to provide a customer centric parking experience.

In one aspect of the present disclosure, corporate customers are presented several means of booking parking. One method commonly used by Corporate Travel Managers is to employ a Third Party Booking Tool such as GetThere.com or Concur.com. Park 'N Fly is the only parking company which is integrated into those tools so booking parking is both convenient and fast. The Park 'N Fly web site, www.pnf.com, provides a second method for those corporate customers to book directly on the web site while still guaranteeing their corporate discounts. The customer simply logs into their Frequent Parker account and chooses to apply their corporate discount and the discounted rates are displayed and all corporate tracking and identification is retained. The customer is also presented, when appropriate, with any loyalty tier discounts and rewards which they can use and redeem for parking. A third method is the same web site functionality delivered on the mobile web site, www.pnf.com/m. A fourth method is also available by simply using their Frequent Parker or Corporate Advantage Program card at the parking facility. The customer may present his card and the system will automatically retrieve the appropriate corporate discount and track the activity accordingly. A fifth method for the corporate customer is to obtain a Park 'N Fly RFID sticker which is then tied to their Frequent Parker account and facilitates information exchanges for valet operations and ticketless parking.

In another embodiment of the present disclosure, a non-corporate customer is provided different methods of reserving parking while retaining loyalty activity and information. For example the non-corporate customer will not typically use the Third Party Booking Tool, but could use FAIRPORTAL.com or similar web access sites. The customer may use the Park 'N Fly web site, www.pnf.com, either anonymously or by logging into their Frequent Parker account. Logging into their account guarantees them identification as a loyal customer and entitles them, depending on their loyalty tier status, to online discounts and rewards which they can use and redeem for parking. A raincheck feature on the Park 'N Fly web site allows customers to claim activity for stays where they were unable to present their Frequent Parker card. A second method is the same web site functionality delivered on the mobile web site, www.pnf.com/m. A third method for the non-corporate customer is to present their Frequent Parker card at the parking facility wherein the system will identify them as a loyal customer and record their activity appropriately. A fourth method for the non-corporate customer is to obtain a Park 'N Fly RFID sticker which is then tied to their Frequent Parker account and facilitates information exchanges for valet operations and ticketless parking.

The method also includes unique functionality which allows a customer to pay with multiple cards or alternate forms of payment and receive separate receipts for each card and/or form of payment. This provides customers sharing parking or splitting the charges to be quickly processed and avoid a long and complicated checkout procedure. Another feature of the method allows the parking to be paid separate and apart from the services. This allows a corporate customer to put their parking on a corporate credit card while presenting a personal credit card for the oil change or car wash. This feature also provides separate receipts for submitting to the expense report as well as a receipt for personal book-keeping.

Another aspect of the present disclosure includes a method of facilitating payment to a seller for a parking service transaction relating to the provision of parking services for a vehicle at a parking location, in exchange for a parking fee, the method comprising the steps of: A) providing parking services for a vehicle at a parking location; B) calculating a parking fee for the vehicle resulting in a payment due; C) receiving a request from at least one of two customers, the two customers including at least a first customer and a second customer, the request being to split the payment due into at least two portions, the two portions including a first payment portion and a second payment portion; D) facilitating a split of the payment due into two portions corresponding to the request in step “C”; E) facilitating the payment of the first payment portion from the first customer to the seller; F) facilitating the payment of the second payment portion from the second customer to the seller; G) determining if the first and second payment portions total the payment; and H) acknowledging completion of the transaction in the event that the first and second payment portions total the payment.

Another aspect of the present disclosure includes a method such as described above, wherein the single transaction relates to the provision of parking services for a vehicle at a parking location, and where step “H” comprises opening a barrier gate to allow the vehicle to exit the location.

Another aspect of the present disclosure includes a method such as described above, wherein step “H” comprises the delivery of at least one receipt to at least one of the at least two customers.

Another aspect of the present disclosure includes a method such as described above, wherein step “H” comprises the delivery of at least one receipt to at least one of the at least two customers.

Another aspect of the present disclosure includes a method such as described above, wherein the split in Step “D” is a 50-50 split between a total of two customers.

Another aspect of the present disclosure includes a method such as described above, wherein the split in Step “D” is between a total of two customers, but is not a 50-50 split.

Another aspect of the present disclosure includes a method of facilitating payment to a seller for a parking service transaction relating to the provision of parking services for a vehicle at a parking location, in exchange for a parking fee, the method comprising the steps of: A) providing parking services for a vehicle at a parking location; B) calculating a parking fee for the vehicle resulting in a payment due; C) receiving a request from at least one of two customers, the two customers including a first customer and a second customer, the request being to split the payment due into two portions, the two portions including a first payment portion and a second payment portion; D) facilitating a split of the payment due into two portions corresponding to the request in step “C”, without voiding the payment due in step “C”; E) facilitating the payment of the first payment portion from the first customer to the seller; F) facilitating the payment of the second payment portion from the second customer to the seller; G) determining if the first and second payment portions total the payment; and H) acknowledging completion of the transaction in the event that the first and second payment portions total the payment.

Another aspect of the present disclosure includes a method such as described above, wherein the single transaction relates to the provision of parking services for a vehicle at a parking location, and where step “H” comprises opening a barrier gate to allow the vehicle to exit the location.

Another aspect of the present disclosure includes a method such as described above, wherein step “H” comprises the delivery of at least one receipt to at least one of the at least two customers.

Another aspect of the present disclosure includes a method such as described above, wherein step “H” comprises the delivery of at least one receipt to at least one of the at least two customers.

Another aspect of the present disclosure includes a method such as described above, wherein the split in Step “D” is a 50-50 split between the first and second customers.

Another aspect of the present disclosure includes a method such as described above, wherein the split in Step “D” is between the first and second customers, but is not a 50-50 split.

Another aspect of the present disclosure includes a method of facilitating payment to a seller for a parking service transaction, the method facilitating multiple payments for corresponding multiple transactions between a seller and a customer, the multiple transactions including the parking service transaction, the multiple payments comprising a total payment due from the seller and the customer, the method comprising the steps of: A) defining multiple transactions between the seller and the customer, by creating a computer record relating to the multiple transactions, the multiple transactions including a first transaction and a second transaction one of which is the parking service transaction; B) facilitating the payment of the first transaction from the customer to the seller; C) facilitating the payment of the second transaction from the customer to the seller; D) determining if the first and second payment portions total the payment; and E) acknowledging completion of the transaction in the event that the first and second payment portions total the payment.

Another aspect of the present disclosure includes a method such as described above, wherein the first and second transactions are facilitated by the use of two corresponding credit cards.

Another aspect of the present disclosure includes a method such as described above, wherein the first transaction relates to the provision of parking services for a vehicle at a parking location, and wherein the second transaction relates to either an oil change or a car wash.

Another aspect of the present disclosure includes a method such as described above, wherein the first transaction relates to the provision of parking services for a vehicle at a parking location, and wherein the second transaction relates to either an oil change or a car wash.

Another aspect of the present disclosure includes a method such as described above, wherein one of the first and second transactions relates to the provision of parking services for a vehicle at a parking location, and wherein step “E” comprises opening a barrier gate to allow the vehicle to exit the location.

Another aspect of the present disclosure includes a method such as described above, wherein step “E” comprises the delivery of at least one receipt to the customer.

Another aspect of the present disclosure includes a method such as described above, wherein step “E” comprises the delivery of at least one receipt to the customer.

Other aspects, features, and advantages of the present invention will become apparent upon reading the following detailed description of the preferred embodiment of the invention when taken in conjunction with the drawing and the appended claims.

### BRIEF DESCRIPTION OF THE DRAWINGS

FIG. 1 is a pictorial diagram illustrating a Third Party Booking Tool 10 (such as GetThere.com or Concur.com) interacting with a Parking Reservation System 20 for corporate customers, according to one embodiment of the present disclosure;

FIG. 2 is a pictorial diagram illustrating the use of the Park 'N Fly (or other suitably named) web site 30 interacting with a Parking Reservation System 20 for corporate customers, according to one embodiment of the present disclosure;

FIG. 3 is a pictorial diagram illustrating the use of the Park 'N Fly (or other suitable named) mobile web site 40 interacting with a Parking Reservation System for corporate customers, according to one embodiment of the present disclosure;

FIG. 4 is a pictorial diagram illustrating the use of a Gate Control System 25 including parking facility entry and exit devices as well as associated software and system elements, to recognize with corporate customers, such as the exemplary Drive-Up Customer 5, according to one embodiment of the present disclosure;

FIG. 5 is a pictorial diagram illustrating the use of RFID technology 50 to recognize corporate customers, according to one embodiment of the present disclosure;

FIG. 6 is a combined pictorial diagram illustrating the plurality of options provided for corporate customers as shown in FIG. 1, FIG. 2, FIG. 3, FIG. 4 and FIG. 5;

FIG. 7 is a pictorial diagram illustrating the use of the Park 'N Fly web site 130 interacting with a Parking Reservation System 120 for non-corporate customers, according to one embodiment of the present disclosure;

FIG. 8 is a pictorial diagram illustrating the use of the Park 'N Fly mobile web site 140 interacting with a Parking Reservation System 120 for non-corporate customers, according to one embodiment of the present disclosure;

FIG. 9 is a pictorial diagram illustrating the use of a Gate Control System 125, including parking facility entry and exit devices as well as associated software and system elements, to recognize with non-corporate customers, such as the exemplary Drive-Up Customer 5, according to one embodiment of the present disclosure;

FIG. 10 is a pictorial diagram illustrating the use of RFID technology 150 to recognize non-corporate customers, according to one embodiment of the present disclosure;

FIG. 11 is a combined pictorial diagram illustrating the plurality of options provided for non-corporate customers as shown in FIG. 7, FIG. 8, FIG. 9 and FIG. 10.

### DETAILED DESCRIPTION AND BEST MODE OF IMPLEMENTATION

Introduction

The present disclosure now will be described more fully hereinafter with reference to the accompanying drawings, in which some, but not all embodiments are shown. This disclosure may be embodied in many different forms and should not be construed as limited to the embodiments set forth herein; rather, these embodiments are provided so that this disclosure will satisfy applicable legal requirements. Like numbers refer to like elements throughout.

Note that for much of the following discussion, “Park 'N Fly” will be referenced as facilitating various processes of the disclosure. However it should be understood that any entity could do so. A “customer” (not shown except generally in the form of a drive-Up Customer 5) is understood to be one being delivered various services, including for example parking services.

### ELEMENT LIST

Here is a list of the various elements:
5—Exemplary Drive-Up Customer
10—Third Party Booking Tool (such as GetThere.com or Concur.com)
15—Park 'N Fly Booking API
20—Parking Reservation System for non-corporate customers
25—Gate Control System
30—Park N Fly Web site
40—Park N Fly Web site
50—RFID Technology
115—Park 'N Fly Booking API
120—Parking Reservation System for non-corporate customers
125—Gate Control System
130—Park N Fly Web site
140—Park N Fly Web site
150—RFID Technology

Discussion

Reference is now made to the figures, in which like elements indicate like elements throughout the several views.

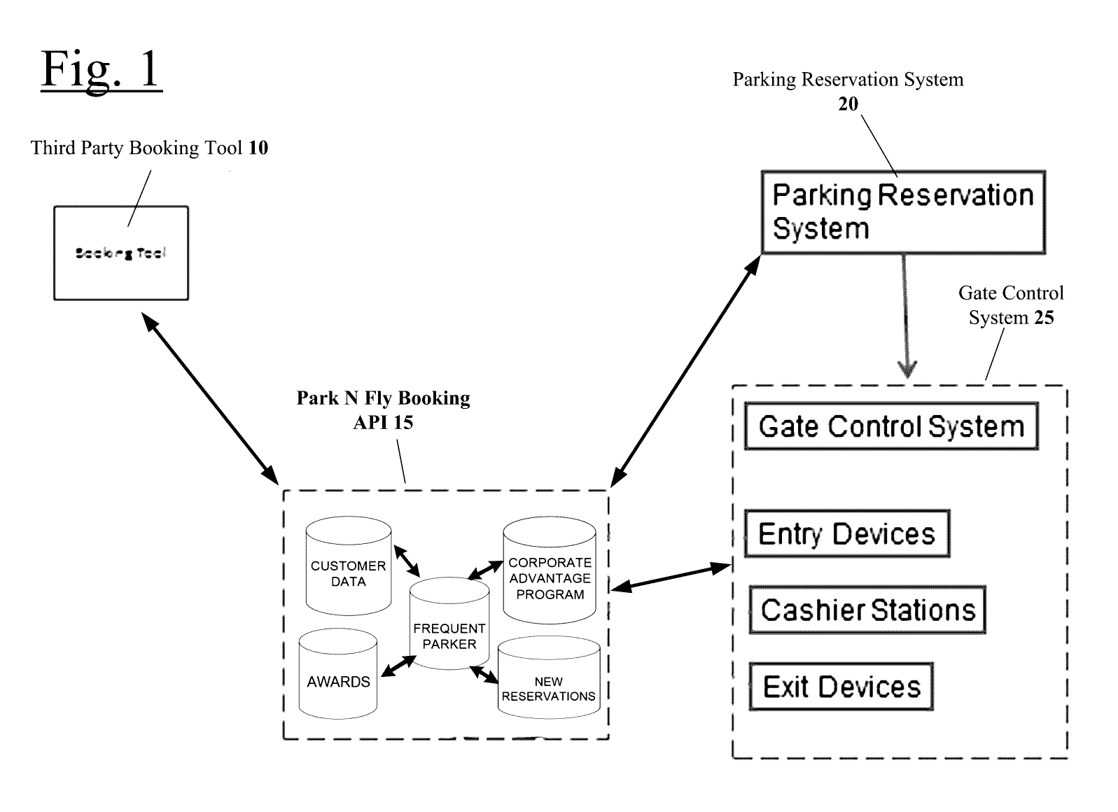

FIG. 1 details a Park 'N Fly API in which is provided to companies which develop, host or provide booking tools for businesses to streamline their purchasing of travel, commonly known as the Park 'N Fly Booking API 15. One customer focused innovation of the disclosure is this API. The API includes the ability to include a Frequent Parker number along with a Corporate Booking ID which allows the customer to earn credits for the activity while guaranteeing the corporate rates negotiated with Park 'N Fly (or any other suitable entity using this disclosure). This provides a unique customer focused advantage since the activity can be done all within the auspices of a Corporate Travel Policy. The reservations, once made, are stored in a Reservation Engine and delivered to the particular Gate Control System used at the lot. Reservations are pre-paid parking so the Gate Control System automatically computes the difference between the pre-paid and actual stay details. Interactions between the Gate Control System, the Corporate Advantage Program and the Frequent Parker system guarantee that the rates are correctly enforced, activity is recorded correctly and revenue is apportioned appropriately.

Note that the Third Party Booking Tool 10 interacting with the Parking Reservation System 20 for corporate customers could also similarly interact with the Parking Reservation System 200 for non-corporate customers referenced elsewhere.

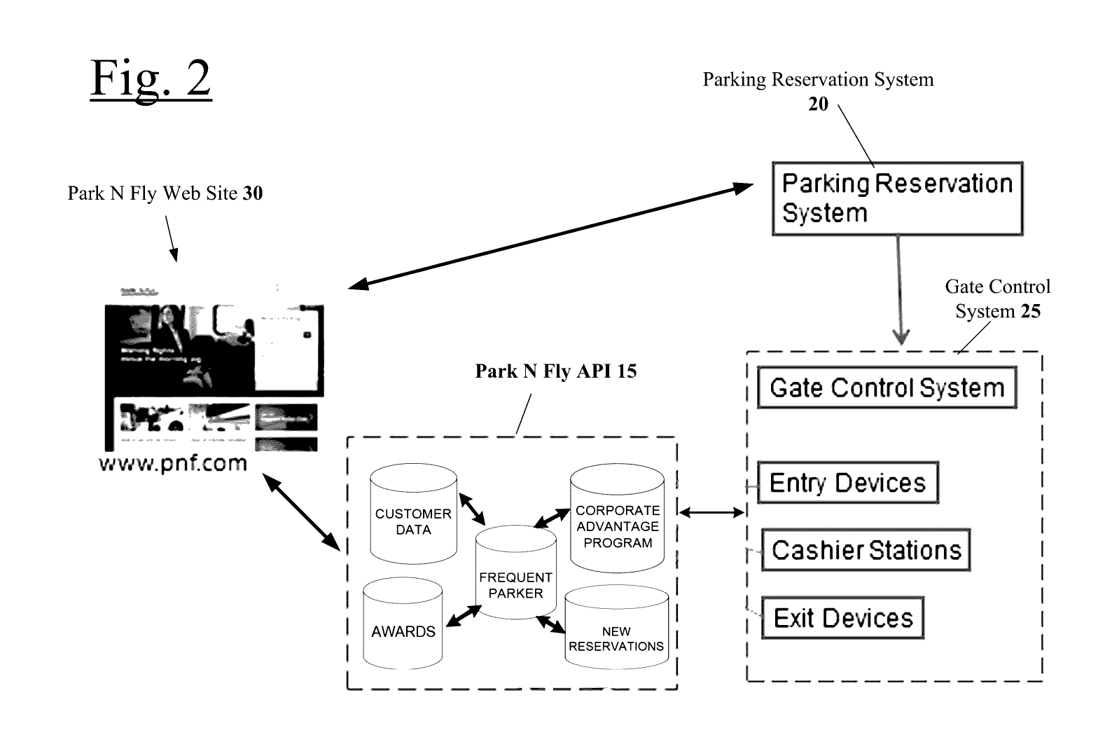

FIG. 2 details the Park 'N Fly web site 30, www.pnf.com, where the innovation supports multiple ways for the customer to engage with Park 'N Fly. It should be understood that the Park 'N Fly name and www.pnf.com address are used as examples; other names and domains could likewise be used.

The customer can initiate the booking process on the home page, specialized landing pages and on facility location pages. The customer is advised to log into their account during the booking flow but the system supports guest bookings as well. Logging into their account will provide data regarding their Frequent Parker account, corporate affiliation, payment preferences and any applicable discounts available to the customer. The customer may select any of the available discount programs and the rates display will refresh with the details for that program and/or discount. This allows the customer to book according to their desires and travel circumstances.

Once logged in, the Frequent Parker number is automatically associated with any bookings and selecting one of the discounts provides valuable tracking data for channel tracking and apportionment. One unique aspect of the disclosure is not necessarily the provision of any one of these options since they may be individually available in the marketplace today, rather it is the plethora of options provided to the customer that constitutes one disclosure innovation. The reservations, once made, are stored in the Reservation Engine and delivered to the Gate Control System used at the lot. Reservations are pre-paid parking so the Gate Control System automatically computes the difference between the pre-paid and actual stay details. Interactions between the Gate Control System, the Corporate Advantage Program and the Frequent Parker system guarantee that the rates are correctly enforced, activity is recorded correctly and revenue is apportioned appropriately.

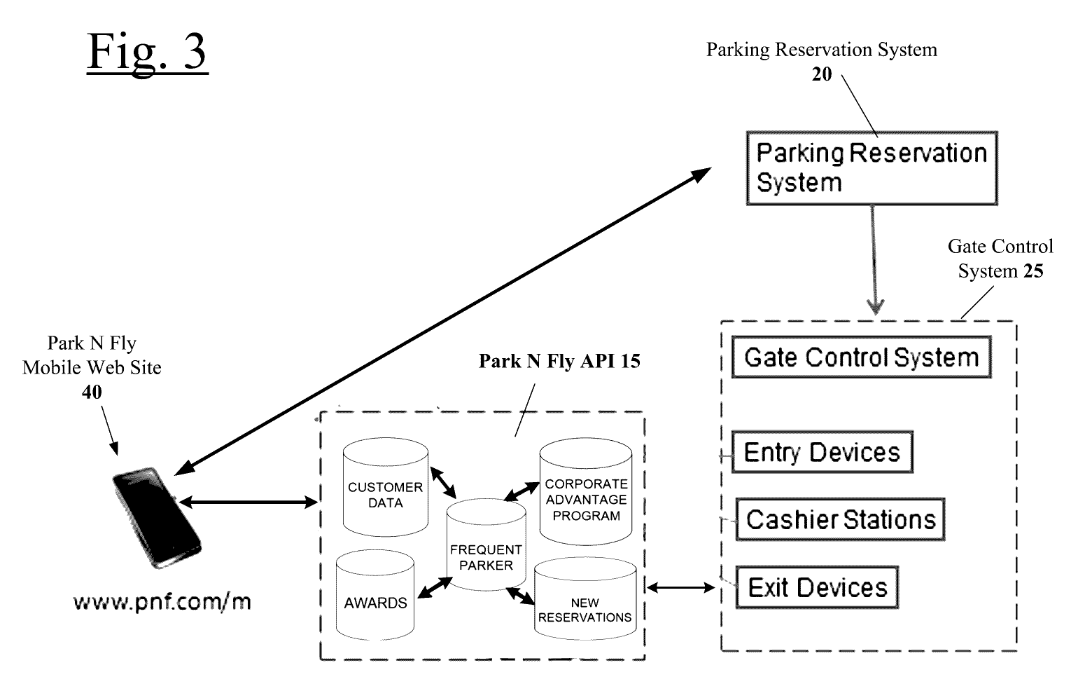

FIG. 3 details the Park 'N Fly mobile web site 40, www.pnf.com/m, where the innovation supports the same multiple ways for the corporate customer to engage with Park 'N Fly as the standard web site. As before, it should be understood that the Park 'N Fly name and www.pnf.com/m web address are used as examples; other names and domains could likewise be used.

The customer can initiate the booking process on the home page, specialized landing pages and on facility location pages. The customer is advised to log into their account during the booking flow but the system supports guest bookings as well. Logging into their account will provide data regarding their Frequent Parker account, corporate affiliation, payment preferences and any applicable discounts available to the customer. The customer may select any of the available discount programs and the rates display will refresh with the details for that program and/or discount. This allows the customer to book according to their desires and travel circumstances.

Once logged in, the Frequent Parker number is automatically associated with any bookings and selecting one of the discounts provides valuable tracking data for channel tracking and apportionment. One unique aspect of the disclosure is not necessarily the provision of any one of these options since they may be individually available in the marketplace today, rather it is the plethora of options provided to the customer that constitutes one disclosure innovation. The reservations, once made, are stored in the Reservation Engine and delivered to the Gate Control System used at the lot. Reservations are pre-paid parking so the Gate Control System automatically computes the difference between the pre-paid and actual stay details. Interactions between the Gate Control System, the Corporate Advantage Program and the Frequent Parker system guarantee that the rates are correctly enforced, activity is recorded correctly and revenue is apportioned appropriately.

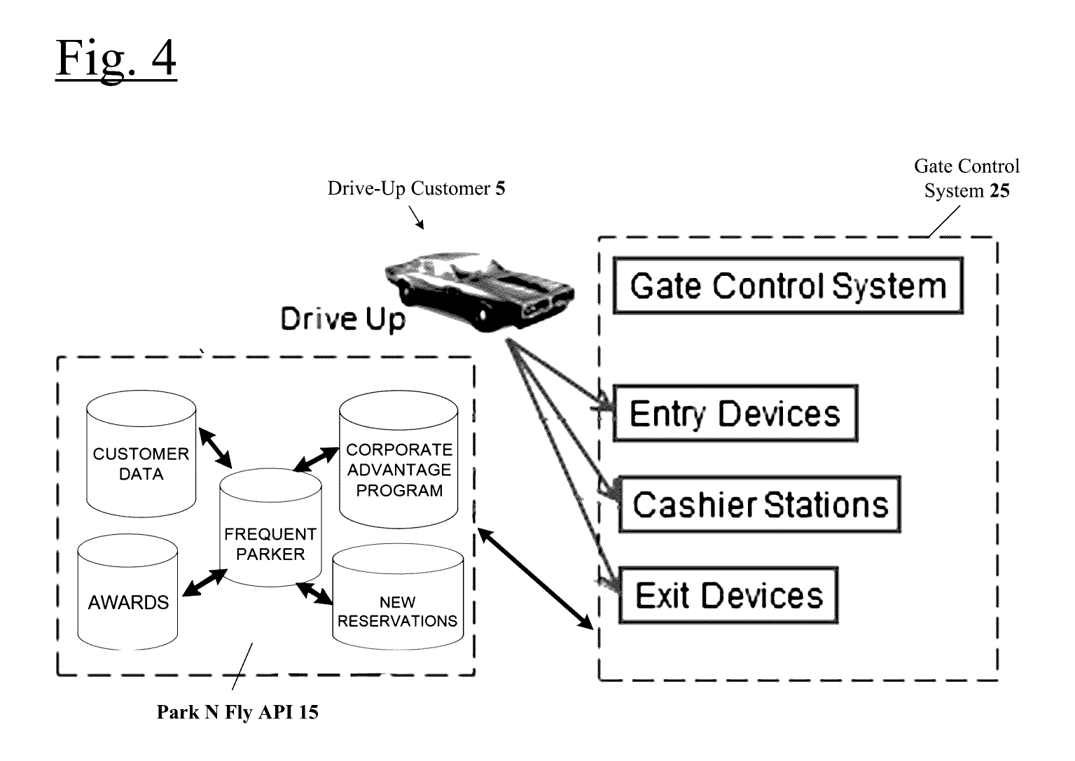

FIG. 4 details the drive up options provided to Drive-Up Customers 5 using Park 'N Fly locations. Customers may use their Frequent Parker card to easily locate pre-reserved reservations and use the Frequent Parker number as a proxy ticket for entry. The Frequent Parker card, in addition, can be used as a Gate Key without a reservation provided that a complete profile has been added to the system. Corporate customers using a Frequent Parker card will automatically retrieve relevant corporate discount information which can be applied to drive-up rates. A number of options are also provided for exiting the facility through cashier stations, dedicated EZExit's, and normal kiosks. The cashier station allows customers to redeem reservations, coupons and apply corporate identification for special discounts and programs.

The method includes unique functionality through the cashier station which allows a customer to pay with multiple cards or alternate forms of payment and receive separate receipts for each card and/or form of payment. An innovation is not just the acceptance of the payment types but also the ease by which the cashier can deliver the functionality. The system supports the ability to check a box that separate receipts are required for each form of payment. Each form of payment is presented and the customer can tell the cashier how much to apply. This allows the customer to control the expenses apportioned to any one occupant of the car. An illustrative example would be a Sales Vice President who is allowed $15 per day for parking while the Sales Engineer is restricted to the $12 rate. The two employees travel together on a 3 day trip parking in a valet, uncovered space at $20 per day. The total amount due is $60 and they want to split the charges. The Sales Vice President presents payment and requests the cashier to deduct $45 of the total on his card. The Sales Engineer then presents payment for the remaining $15 of the charge. Two receipts would be produced and the customers would be free to leave. In a non-optimized system, the flow would have been to void the original ticket and then try to create two new tickets with the corresponding charges. The innovation saves valuable cashier steps and time as well as facilitating the primary objective of getting the customer settled and on the road. The system also allows this flexibility to be extended to parking and/or services. In our previous example, the Sales Engineer needs an emission inspection and oil change. He could still add the services to the original ticket and request a split by parking and services. The previous payment scenario would be handled for parking and the Sales Engineer would then present the payment details for the services. This allows the employees to present receipts and/or use of the corporate credit card for parking and provide other payment instructions for services, which are not typically picked up on the expense report. These features provide customers sharing parking, using services or splitting the charges to be quickly processed and avoid a long and complicated checkout procedure. Sharing can be by percentage, or can be done by selecting defined values.

Another feature of the method allows the parking to be paid separate and apart from the services. This allows a corporate customer to put their parking on a corporate credit card while presenting a personal credit card for the oil change or car wash. This feature also provides separate receipts for submitting to the expense report as well as a receipt for personal book-keeping. Interactions between the Gate Control System, the Corporate Advantage Program and the Frequent Parker system guarantee that the rates are correctly enforced, activity is recorded correctly and revenue is apportioned appropriately.

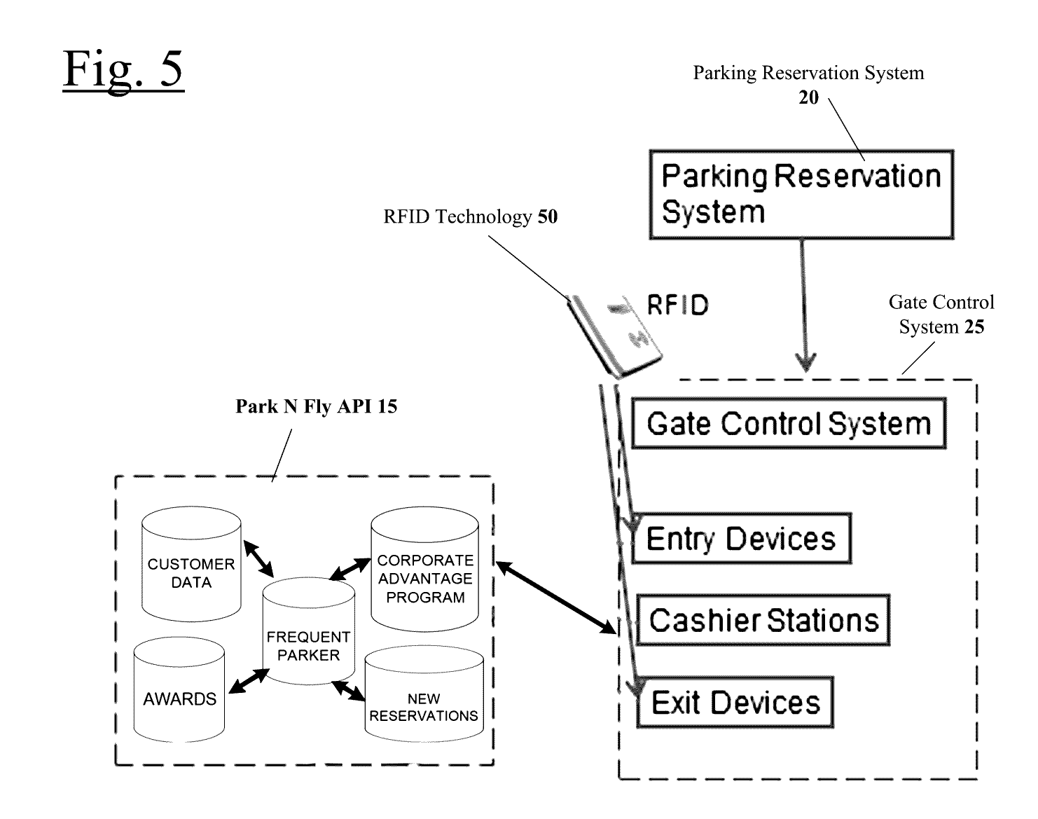

FIG. 5 details the customer centric focus for the RFID functionality provided in the cross platform, multi-component customer centric system for parking. RFID Technology 50 such as the shown RFID tag, which is optionally placed in a customer car, acts as another identifier for the Frequent Parker and Corporate Advantage Program. RFID readers proximate the entry and exit devices within the Gate Control system at the lot read the tag and will try to locate the customer's information automatically, saving the customer time and the inconvenience of entering their card. Park 'N Fly's Frequent Parker system holds RFID information along with Car and Driver details to simplify the experience of using our Valet parking options. This provides the corporate customer with the invaluable advantage of both speed and convenience in using the cross-platform, multi-component customer centric system for parking.

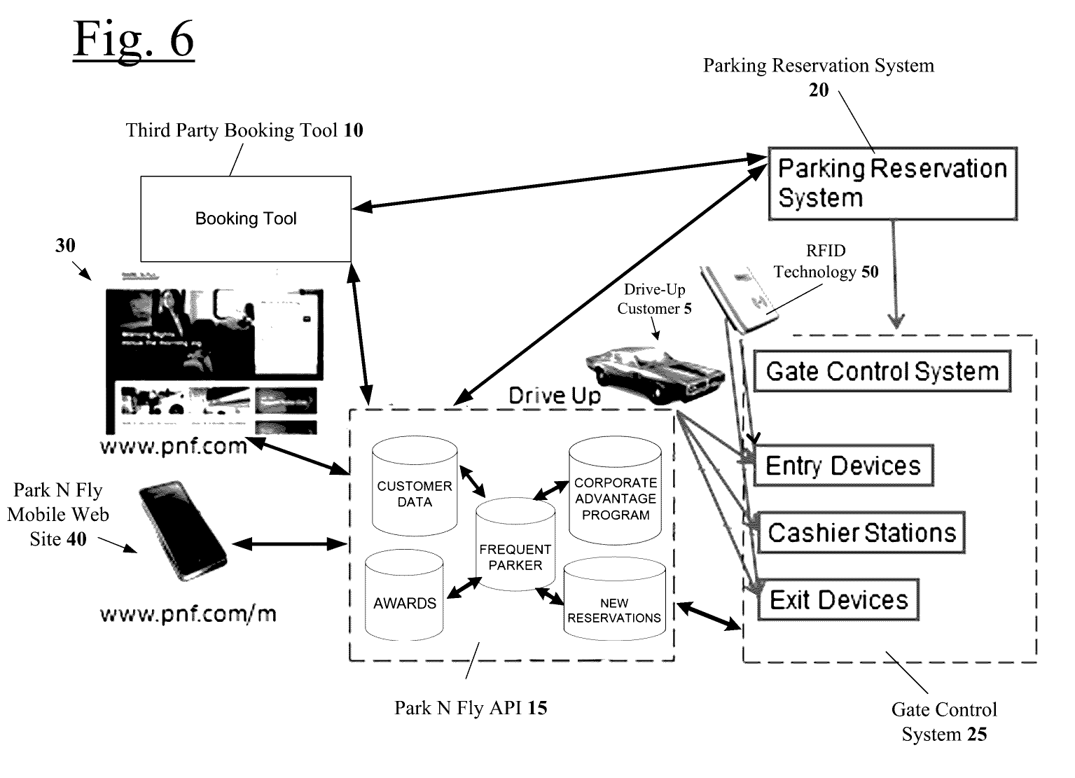

FIG. 6 displays the disclosure innovation, namely the plethora of customer centric options available to our corporate customers in which they may tailor their forms of engagement and interactions with Park 'N Fly to best suit their personal, travel and corporate needs.

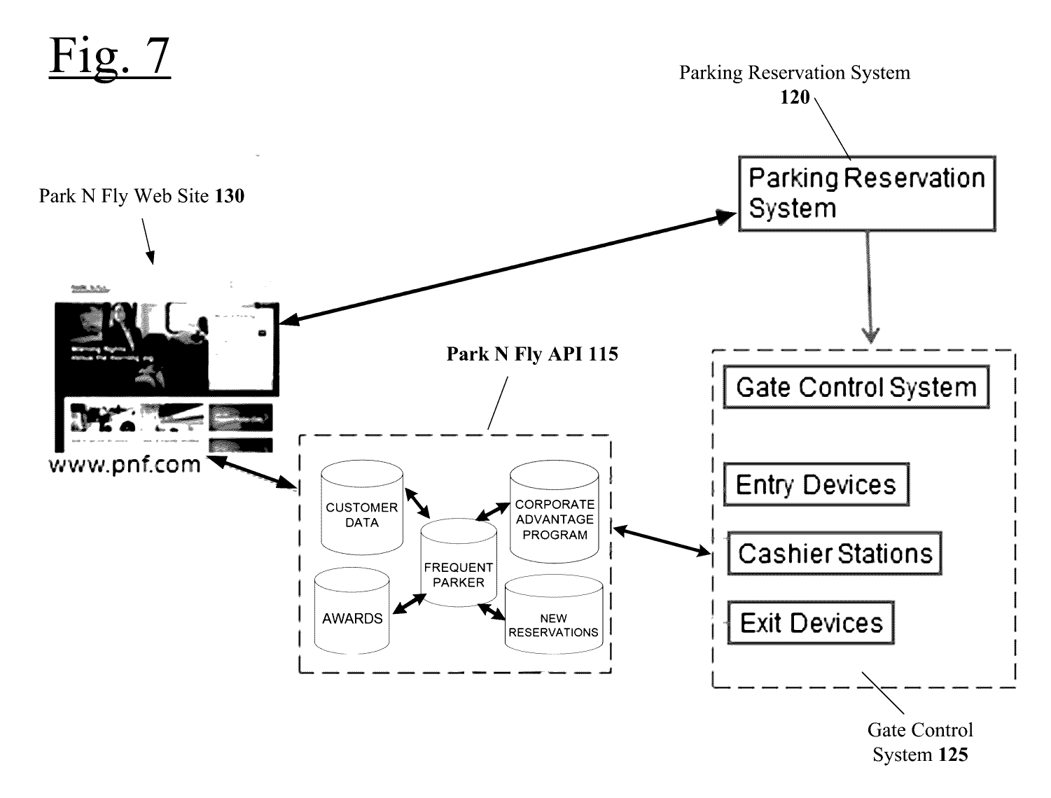

FIG. 7 details the Park 'N Fly web site 130, www.pnf.com, where the innovation supports multiple ways for the non-corporate customer to engage with Park 'N Fly via the Park 'N Fly API 115. It should be understood that the Park 'N Fly name and www.pnf.com address are used as examples; other names and domains could likewise be used.

The customer can initiate the booking process on the home page, specialized landing pages and on facility location pages. The customer is advised to log into their account during the booking flow but the system supports guest bookings as well. Logging into their account will provide data regarding their Frequent Parker account, payment preferences and any applicable discounts available to the customer. The user may select any of the available discount programs and the rates display will refresh with the details for that program and/or discount. This allows the customer to book according to their desires and travel circumstances.

Once logged in, the Frequent Parker number is automatically associated with any bookings and selecting one of the discounts provides valuable tracking data for channel tracking and apportionment. One unique aspect of the disclosure is not necessarily the provision of any one of these options since they may be individually available in the marketplace today, rather it is the plethora of options provided to the customer that constitutes one disclosure innovation. The reservations, once made, are stored in the Reservation Engine and delivered to the Gate Control System used at the lot. Reservations are pre-paid parking so the Gate Control System automatically computes the difference between the pre-paid and actual stay details. Interactions between the Gate Control System and the Frequent Parker system guarantee that the rates are correctly enforced, activity is recorded correctly and revenue is apportioned appropriately.

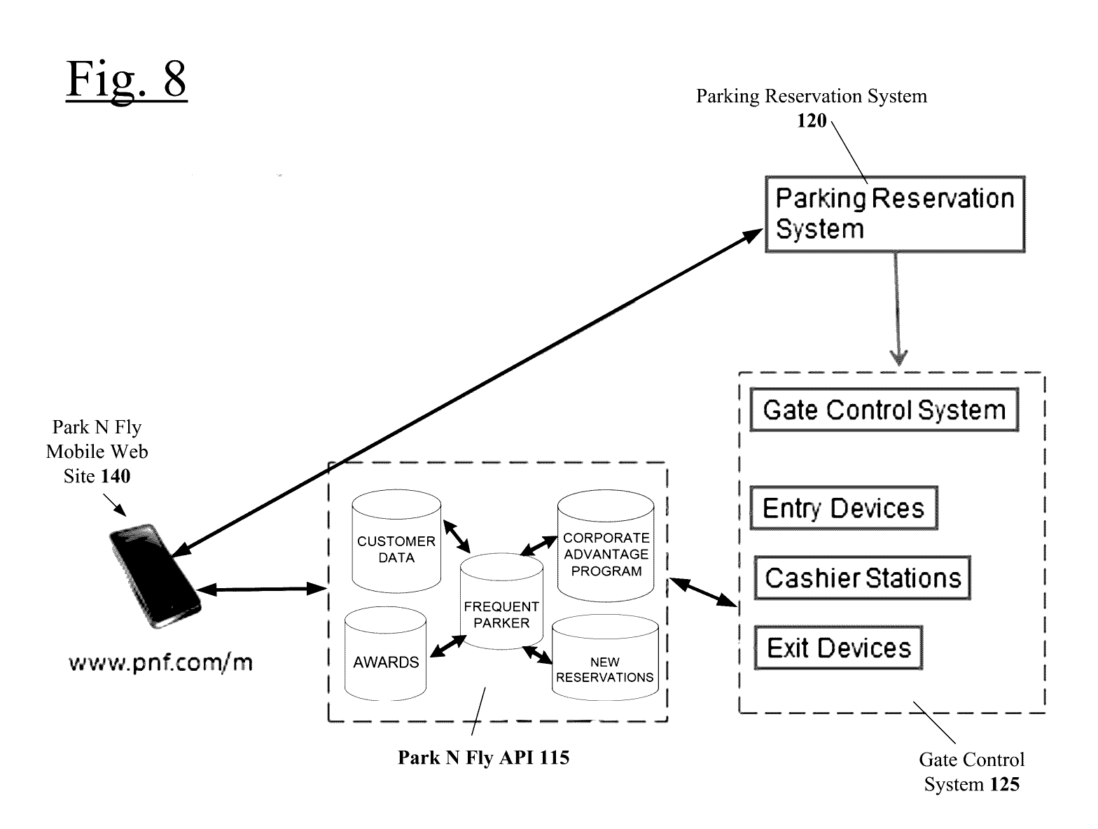

FIG. 8 details the Park 'N Fly mobile web site 140, www.pnf.com/m, where the innovation supports the same multiple ways for the non-corporate customer to engage with Park 'N Fly as the standard web site. As before, it should be understood that the Park 'N Fly name and www.pnf.com/m web address are used as examples; other names and domains could likewise be used.

The customer can initiate the booking process on the home page, specialized landing pages and on facility location pages. The customer is advised to log into their account during the booking flow but the system supports guest bookings as well. Logging into their account will provide data regarding their Frequent Parker account, payment preferences and any applicable discounts available to the customer. The user may select any of the available discount programs and the rates display will refresh with the details for that program and/or discount. This allows the customer to book according to their desires and travel circumstances.

Once logged in, the Frequent Parker number is automatically associated with any bookings and selecting one of the discounts provides valuable tracking data for channel tracking and apportionment. One unique aspect of the disclosure is not necessarily the provision of any one of these options since they may be individually available in the marketplace today, rather it is the plethora of options provided to the customer that constitutes one disclosure innovation. The reservations, once made, are stored in the Reservation Engine and delivered to the Gate Control System used at the lot. Reservations are pre-paid parking so the Gate Control System automatically computes the difference between the pre-paid and actual stay details. Interactions between the Gate Control System and the Frequent Parker system guarantee that the rates are correctly enforced, activity is recorded correctly and revenue is apportioned appropriately.

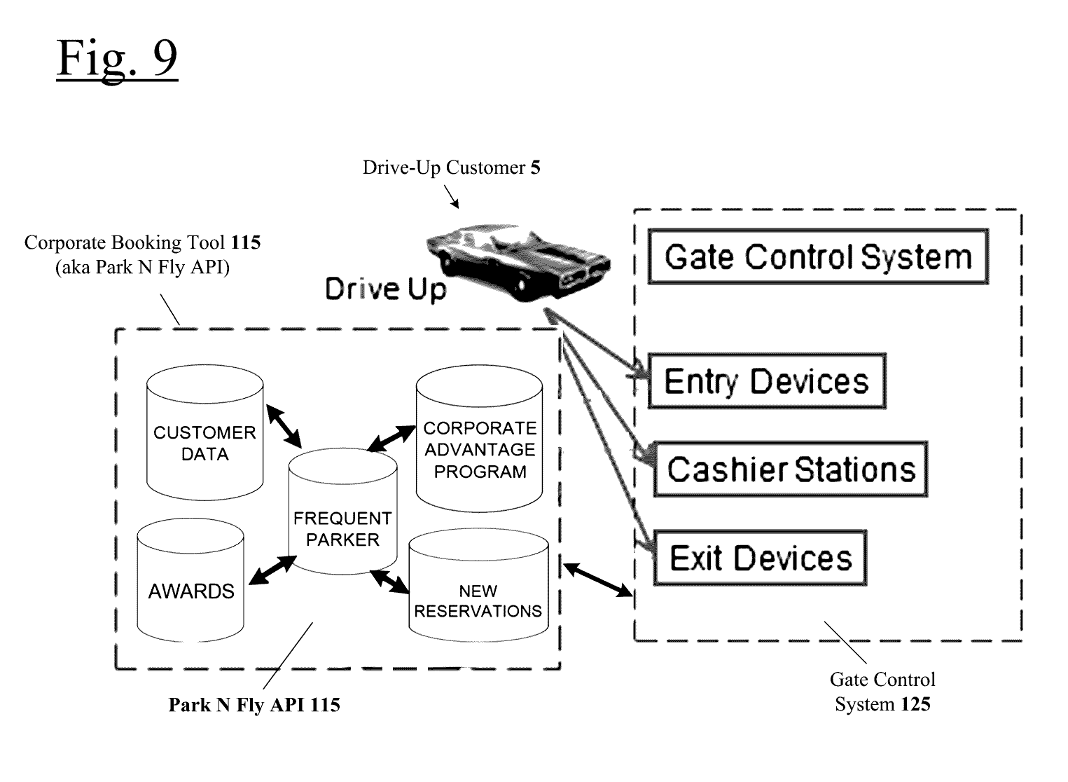

FIG. 9 details the drive up options provided to customers using Park 'N Fly locations. Customers may use their Frequent Parker card to easily locate pre-reserved reservations and use the Frequent Parker number as a proxy ticket for entry. The Frequent Parker card, in addition, can be used as a Gate Key without a reservation provided that a complete profile has been added to the system. A number of options are also provided for exiting the facility through cashier stations, dedicated EZExit's, and normal kiosks. The cashier station allows customers to redeem reservations, coupons and apply identification for special discounts and programs. The method also includes unique functionality through the cashier station which allows a customer to pay with multiple cards or alternate forms of payment and receive separate receipts for each card and/or form of payment. This provides customers sharing parking or splitting the charges to be quickly processed and avoid a long and complicated checkout procedure. Another feature of the method allows the parking to be paid separate and apart from the services. This allows a customer to put their parking on one credit card while presenting a personal credit card or debit card for the oil change or car wash. This feature also provides separate receipts for each of the payment types for personal book-keeping. Interactions between the Gate Control System and the Frequent Parker system guarantee that the rates are correctly enforced, activity is recorded correctly and revenue is apportioned appropriately.

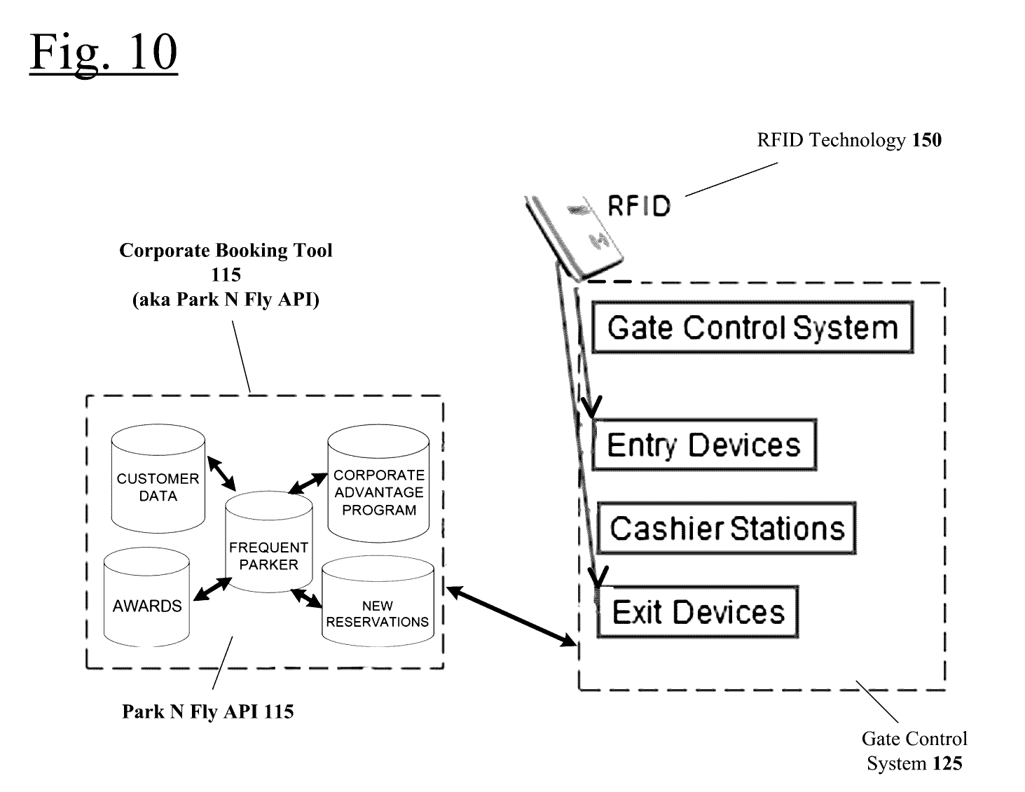

FIG. 10 details the customer centric focus for the RFID functionality provided in the cross platform, multi-component customer centric system for parking. RFID Technology 150 such as the shown RFID tag, which is optionally placed in a customer car, acts as another identifier for the Frequent Parker. RFID readers proximate the entry and exit devices within the Gate Control system at the lot read the tag and will try to locate the customer's information automatically, saving the customer time and the inconvenience of entering their card. Park 'N Fly's Frequent Parker system holds RFID information along with Car and Driver details to simplify the experience of using our Valet parking options. This provides the non-corporate customer with the invaluable advantage of both speed and convenience in using the cross-platform, multi-component customer centric system for parking.

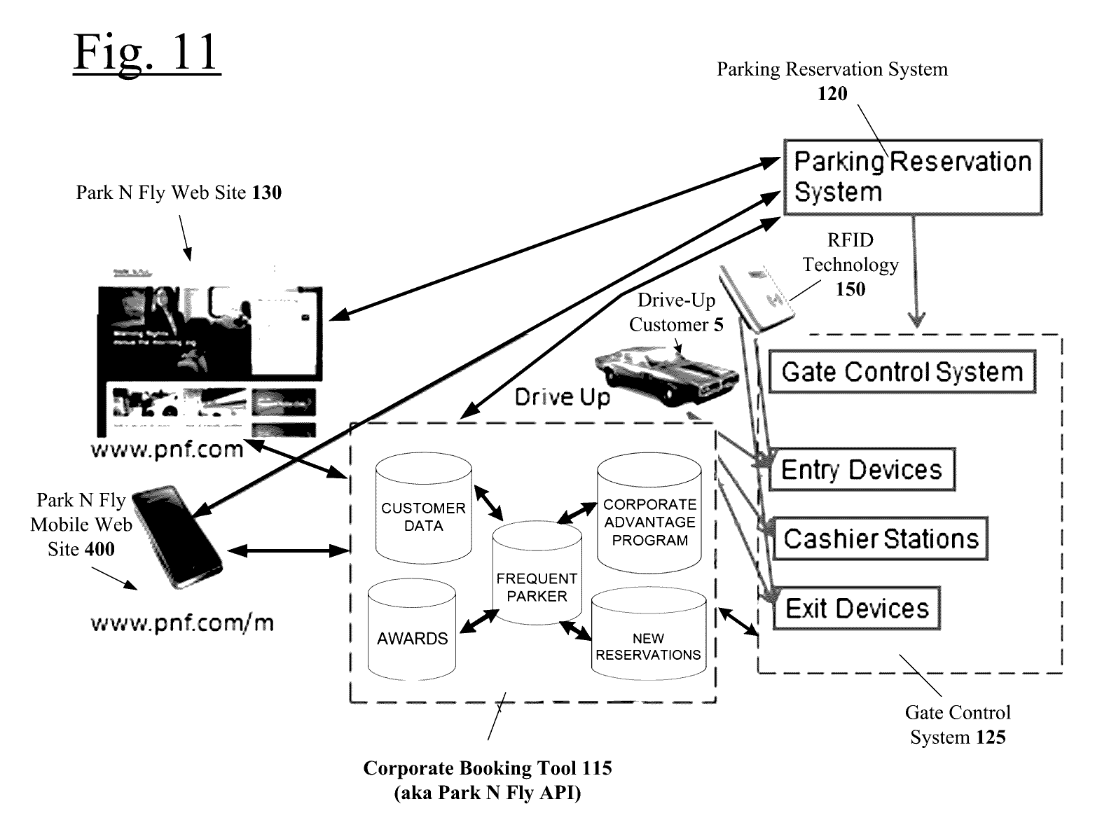

FIG. 11 displays the disclosure innovation, namely the plethora of customer centric options available to our non-corporate customers in which they may tailor their forms of engagement and interactions with Park 'N Fly to best suit their personal, travel and family needs.

Note that while the web site 30 has been described separately than the web site 130, for different customers, the same web site could be used to accommodate both customers.

Note that while the web site 40 has been described separately than the web site 140, for different customers, the same web site could be used to accommodate both customers.

Note that the functionality of the Park 'N Fly Booking API 15 could be similar to the functionality of the Park 'N Fly Booking API 115, and could be combined.

Note that the functionality of the Parking Reservation System 20 could be similar to the functionality of the Parking Reservation System 120, and could be combined.

Note that the functionality of the Gate Control System 25 could be similar to the functionality of the Gate Control System 125, and could be combined.

Note that the functionality of the RFID technology 50 could be similar to the functionality of the RFID technology 150, and could be combined.

Conclusion

In conclusion, the present disclosures provide highly convenient and complex processing to enable customer centric payment of parking and services together or separately, as well as with multiple forms of payment. The method includes the use of a Parking Reservations Engine in so far as it is used to support or facilitate customer centric processing. The method also includes the use of a Customer Loyalty system in the extensions and innovations necessary to support this customer centric parking disclosure. The innovation centralizes around the methods and extensions provided by each of the components as well as the novelty of the Gate Control System in enabling these methods and extensions to provide a customer centric parking experience.

It should be understood that the discussion of any embodiment is meant only to be exemplary and is not intended to suggest that the scope of the disclosure, including the claims, is limited to these examples.

What is claimed is:

1) A method of facilitating payment to a seller for a parking service transaction relating to the provision of parking services for a vehicle at a parking location, in exchange for a parking fee, said method comprising the steps of:
A) providing parking services for a vehicle at a parking location;
B) calculating a parking fee for said vehicle resulting in a payment due;
C) receiving a request from at least one of two customers, said two customers including at least a first customer and a second customer, said request being to split said payment due into at least two portions, said two portions including a first payment portion and a second payment portion;
D) facilitating a split of said payment due into two portions corresponding to the request in step “C”;
E) facilitating the payment of said first payment portion from said first customer to said seller;
F) facilitating the payment of said second payment portion from said second customer to said seller;
G) determining if said first and second payment portions total said payment; and
H) acknowledging completion of said transaction in the event that said first and second payment portions total said payment.

2) The method as claimed in claim 1, wherein said single transaction relates to the provision of parking services for a vehicle at a parking location, and where step “H” comprises opening a barrier gate to allow said vehicle to exit said location.

3) The method as claimed in claim 2, wherein step “H” comprises the delivery of at least one receipt to at least one of said at least two customers.

4) The method as claimed in claim 1, wherein step “H” comprises the delivery of at least one receipt to at least one of said at least two customers.

5) The method as claimed in claim 1, wherein said split in Step “D” is a 50-50 split between a total of two customers.

6) The method as claimed in claim 1, wherein said split in Step “D” is between a total of two customers, but is not a 50-50 split.

7) A method of facilitating payment to a seller for a parking service transaction relating to the provision of parking services for a vehicle at a parking location, in exchange for a parking fee, said method comprising the steps of:
A) providing parking services for a vehicle at a parking location;
B) calculating a parking fee for said vehicle resulting in a payment due;
C) receiving a request from at least one of two customers, said two customers including a first customer and a second customer, said request being to split said payment due into two portions, said two portions including a first payment portion and a second payment portion;
D) facilitating a split of said payment due into two portions corresponding to the request in step “C”, without voiding said payment due in step “C”;
E) facilitating the payment of said first payment portion from said first customer to said seller;
F) facilitating the payment of said second payment portion from said second customer to said seller;
G) determining if said first and second payment portions total said payment; and
H) acknowledging completion of said transaction in the event that said first and second payment portions total said payment.

8) The method as claimed in claim 7, wherein said single transaction relates to the provision of parking services for a vehicle at a parking location, and where step “H” comprises opening a barrier gate to allow said vehicle to exit said location.

9) The method as claimed in claim 8, wherein step “H” comprises the delivery of at least one receipt to at least one of said at least two customers.

10) The method as claimed in claim 7, wherein step “H” comprises the delivery of at least one receipt to at least one of said at least two customers.

11) The method as claimed in claim 7, wherein said split in Step “D” is a 50-50 split between said first and second customers.

12) The method as claimed in claim 7, wherein said split in Step “D” is between said first and second customers, but is not a 50-50 split.

13) A method of facilitating payment to a seller for a parking service transaction, said method facilitating multiple payments for corresponding multiple transactions between a seller and a customer, said multiple transactions including said parking service transaction, said multiple payments comprising a total payment due from said seller and said customer, said method comprising the steps of:
A) defining multiple transactions between said seller and said customer, by creating a computer record relating to said multiple transactions, said multiple transactions including a first transaction and a second transaction one of which is said parking service transaction;
B) facilitating the payment of said first transaction from said customer to said seller;
C) facilitating the payment of said second transaction from said customer to said seller;
D) determining if said first and second payment portions total said payment; and
E) acknowledging completion of said transaction in the event that said first and second payment portions total said payment.

14) The method as claimed in claim 13, wherein said first and second transactions are facilitated by the use of two corresponding credit cards.

15) The method as claimed in claim 14, wherein said first transaction relates to the provision of parking services for a vehicle at a parking location, and wherein said second transaction relates to either an oil change or a car wash.

16) The method as claimed in claim 13, wherein said first transaction relates to the provision of parking services for a vehicle at a parking location, and wherein said second transaction relates to either an oil change or a car wash.

17) The method as claimed in claim 13, wherein one of said first and second transactions relates to the provision of parking services for a vehicle at a parking location, and wherein step “E” comprises opening a barrier gate to allow said vehicle to exit said location.

18) The method as claimed in claim 17, wherein step “E” comprises the delivery of at least one receipt to said customer.

19) The method as claimed in claim 13, wherein step “E” comprises the delivery of at least one receipt to said customer.
